(19) United States
(12) Patent Application Publication
(10) Pub. No.: US 2013/0013701 A1
(43) Pub. Date: Jan. 10, 2013

(54) OPEN INVITE FOR VIDEO CALLS

(75) Inventors: Ravikant Cherukuri, Snoqualmie, WA (US); Nalin Kumar, Redmond, WA (US)

(73) Assignee: Microsoft Corporation, Redmond, WA (US)

(21) Appl. No.: 13/179,557

(22) Filed: Jul. 10, 2011

(51) Int. Cl. G06F 15/16

(52) U.S. Cl. 709/206

(57) ABSTRACT

In one embodiment, a video chat source 102 may establish a video chat session with a video chat target 104 regardless of membership in a mutual video chat service. A processor 220 may enclose in a chat invitation message 300 a video chat establishment code 340 to initiate a video chat session. A communication interface 280 may send the chat invitation message 300 to a video chat target 104.

### BACKGROUND

Most modern personal computing devices may come equipped with a digital video camera, allowing a user to perform video chatting with another user. The personal computing devices may be desktop computers, laptop computers, tablet computers, or smart phones. The chatting users may both belong to a video chatting service that facilitates the video chat. A user initiating the video chat may pre-arrange the video chat with the other participating user or users.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to establishing a video chat session with a video chat target regardless of membership in a mutual video chat service. A processor may enclose in a chat invitation message a video chat establishment code to initiate a video chat session. A communication interface may send the chat invitation message to a video chat target.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a video chat session.

FIG. 2 illustrates, in a block diagram, one embodiment of a handheld computing device.

FIG. 3 illustrates, in a block diagram, one embodiment of a chat invitation message.

FIGS. 4A-B illustrate, in two block diagrams, embodiments of an embedded video chat user interface.

FIG. 5 illustrates, in a flowchart, one embodiment of a method of initiating a video chat with a video chat target.

FIG. 6 illustrates, in a flowchart, one embodiment of a method of receiving a video chat initiation from a video chat source.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a computing device acting as a video chat source or target.

A source user and a target user wanting to have a video chat may both be members of the same video chat service. The source user may place the target user on an access control list. An access control list is a list of video chat service members verified and approved for video chats by both users. The source user may invite the target user to join the video chat service and the access control list of the target user.

However, by creating a portable video chat establishment code, a user may initiate video chat sessions with users not in the video chat service. The user may send the video chat establishment code to anyone in the general contact list of the user. The general contact list is a list of contact points across multiple services. The source user may use multiple different contact points for the target user, such as a social network page, an electronic mail address, short messaging service texting number, or an instant messaging address. Upon receiving the video chat establishment code, the target user may use the video chat establishment code to establish a video chat session with the source user.

Thus, in one embodiment, a video chat source may establish a video chat session with a video chat target regardless of membership in a mutual video chat service. A processor may enclose in a chat invitation message a video chat establishment code to initiate a video chat session. A communication interface may send the chat invitation message to a video chat target.

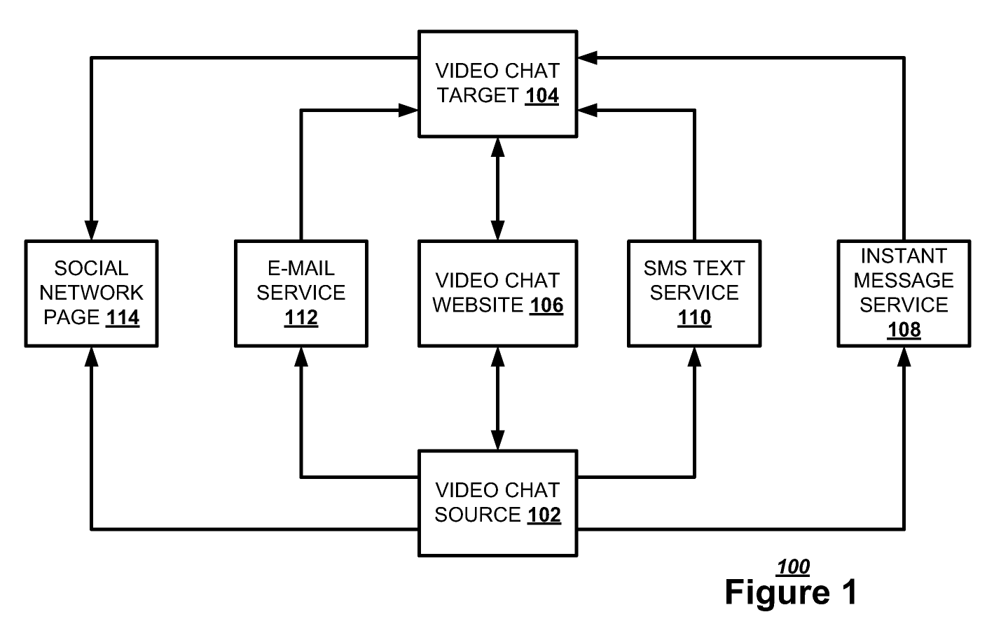

FIG. 1 illustrates, in a block diagram, one embodiment of a video chat session 100. A user may use a computing device, referred to herein as a video chat source 102, to initiate a video chat session with a second user on a second computing device, referred to herein as a video chat target 104, using a video chat service. The computing device of a user may be a video chat source 102 in one video chat session, and a video chat target 104 in a different video chat session or in the same video chat session, in the case of a three way video chat. The video chat source 102 sends an invitation for the video chat session to the video chat target 104. Neither the video chat source 102 nor the video chat target 104 has to belong to the video chat service to create a video chat session.

A video chat website 106 may operate the video chat service. The video chat source 102 may access the video chat website 106 to download a video chat establishment code. The video chat establishment code may be a piece of software, such as a set of hypertext markup language or JavaScript®, that may establish a video chat session. The video chat session may be executed through the video chat website 106 or independently of the video chat website 106. By generating a portable video chat establishment code, the video chat source 102 may create a video chat session independent of the video chat service.

The video chat source 102 may enclose the video chat establishment code in a chat invitation message. The video chat source 102 may then send the chat invitation message. The chat invitation message may be an instant message sent over an instant message service 108. The chat invitation message may be a short message service (SMS) text sent over a short message service text service 110. The chat invitation message may be an electronic mail message sent over an electronic mail service 112. The chat invitation message may be a social network page post posted on the social network page 114 of the video chat target user.

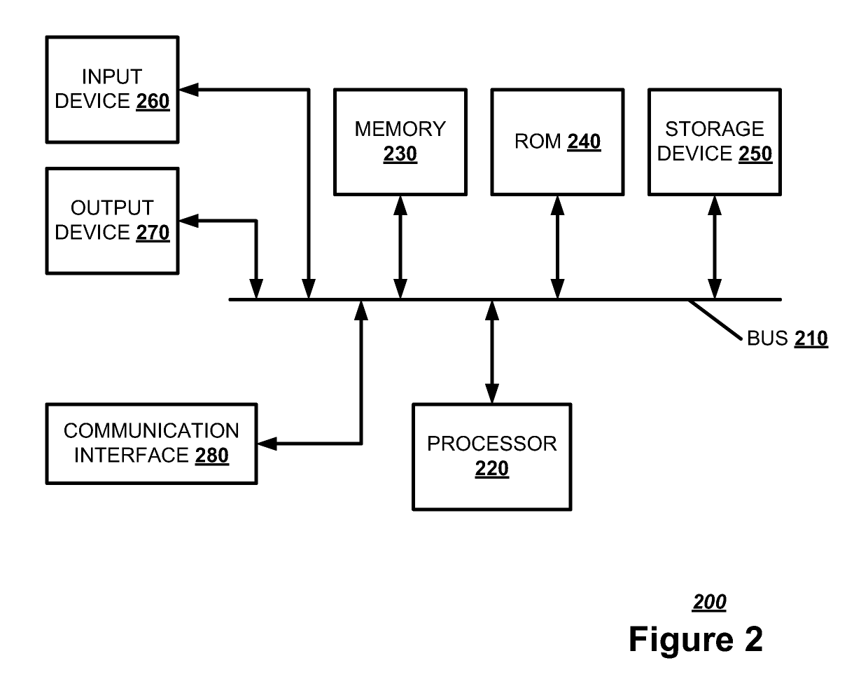

FIG. 2 illustrates a block diagram of an exemplary computing device 200 which may act as a video chat source or a video chat target. The computing device 200 may combine one or more of hardware, software, firmware, and system-on-a-chip technology to create or join the video chat session. The computing device 200 may include a bus 210, a processor 220, a memory 230, a read only memory (ROM) 240, a storage device 250, an input device 260, an output device 270, and a communication interface 280. The bus 210 may permit communication among the components of the computing device 200.

The processor 220 may include at least one conventional processor or microprocessor that interprets and executes a set of instructions. The memory 230 may be a random access memory (RAM) or another type of dynamic storage device that stores information and instructions for execution by the processor 220. The memory 230 may also store temporary variables or other intermediate information used during execution of instructions by the processor 220. The ROM 240 may include a conventional ROM device or another type of static storage device that stores static information and instructions for the processor 220. The storage device 250 may include any type of tangible machine-readable medium, such as, for example, magnetic or optical recording media and its corresponding drive. The storage device 250 may store a set of instructions detailing a method that when executed by one or more processors cause the one or more processors to perform the method.

The input device 260 may include one or more conventional mechanisms that permit a user to input information to the computing device 200, such as a keyboard, a mouse, a voice recognition device, a microphone, a headset, a digital video camera, etc. The output device 270 may include one or more conventional mechanisms that output information to the user, including a display, a printer, one or more speakers, a headset, or a medium, such as a memory, or a magnetic or optical disk and a corresponding disk drive. The communication interface 280 may include any transceiver-like mechanism that enables processing device 200 to communicate with other devices or networks. The communication interface 280 may include a network interface or a mobile transceiver interface. The communication interface 280 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the storage device 250, or from a separate device via the communication interface 280.

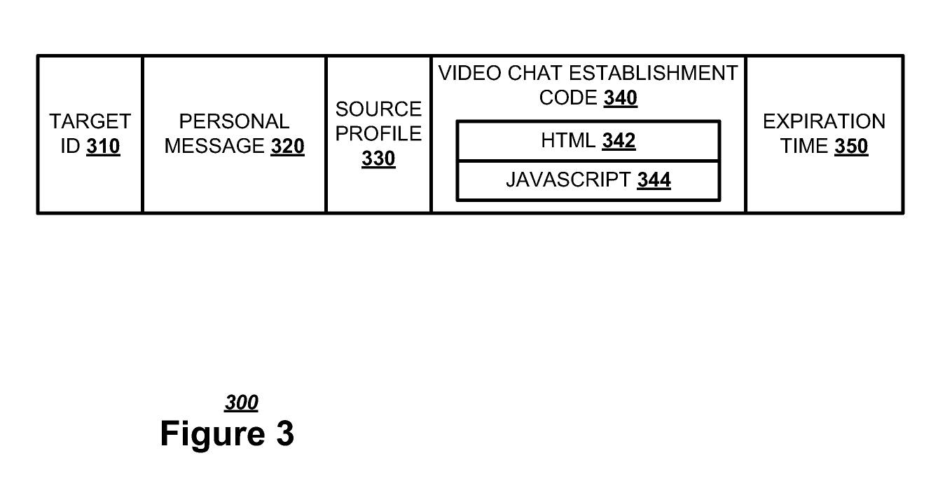

FIG. 3 illustrates, in a block diagram, one embodiment of a chat invitation message 300. The chat invitation message 300 may have a target identifier 302 identifying the video chat target 104. The chat invitation message 300 may have a personal message 320, allowing the video chat source user 102 to include a personalized greeting in the request for the video chat session. The chat invitation message 300 may have a video chat source profile 330 that provides a description of the video chat source user 102, or a link to such a description. The chat invitation message 300 may have a video chat establishment code 340 to allow the video chat target 104 to establish a video chat session. The video chat establishment code 340 may be in hypertext markup language (HTML) 342 or in JavaScript® 344. The chat invitation message 300 may have an expiration time 350 signaling when the video chat source 102 is no longer available for a video chat session.

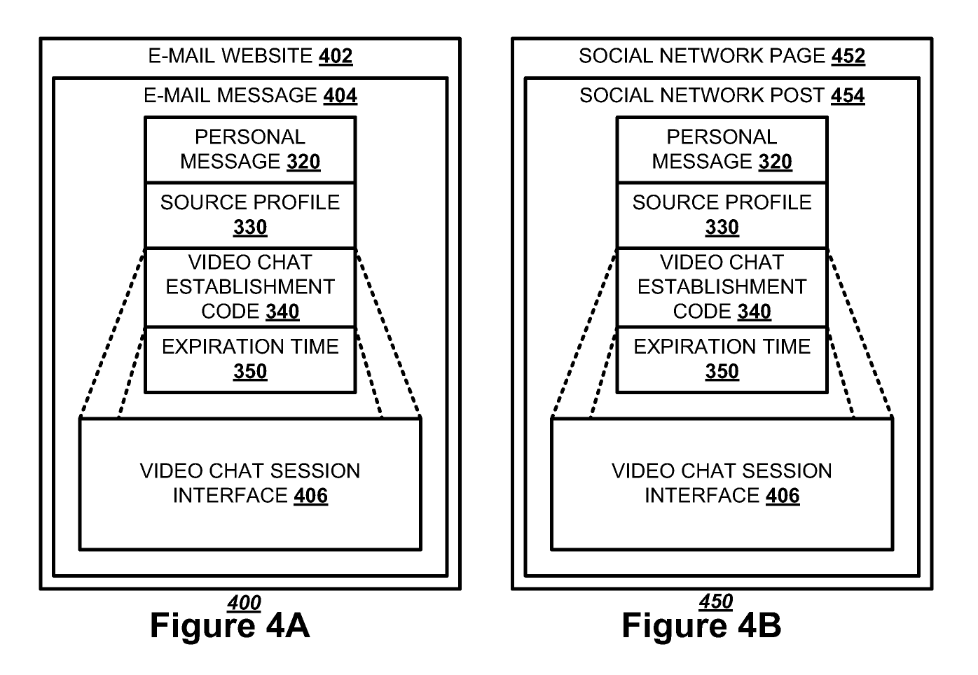

The chat invitation message 300 may include greater functionality to enhance the user experience. FIG. 4A illustrates, in a block diagram, one embodiment of a mail embedded video chat user interface 400. An electronic mail website 402 may display a chat invitation message as an electronic mail message 404 to a video chat target user 104. The electronic mail message 404 may have a personal message 320 from the video chat source user 102. The electronic mail message 404 may have a video chat source profile 330 that provides a description of the video chat source user 102, or a link to such a description. The electronic mail message 404 may have an expiration time 350. The electronic mail message 404 may display the expiration time 350 as an exact time or as a countdown to the expiration. The electronic mail message 404 may have a video chat establishment code 340. When the video chat target user 104 selects the video chat establishment code 340, the video chat establishment code may generate a video chat session interface 406 embedded in the electronic mail message 404.

FIG. 4B illustrates, in a block diagram, one embodiment of a social network embedded video chat user interface 450. A social network page 452 associated with the video chat target user 104 may display a chat invitation message as a social network post 454 to a video chat target user 104. The social network post 454 may have a personal message 320 from the video chat source user 102. The social network post 454 may have a video chat source profile 330 that provides a description of the video chat source user 102, or a link to such a description. The social network post 454 may have an expiration time 350. The social network post 454 may display the expiration time 350 as an exact time or as a countdown to the expiration. The social network post 454 may have a video chat establishment code 340. When the video chat target user 104 selects the video chat establishment code 340, the video chat establishment code may generate a video chat session interface 406 embedded in the social network post 454.

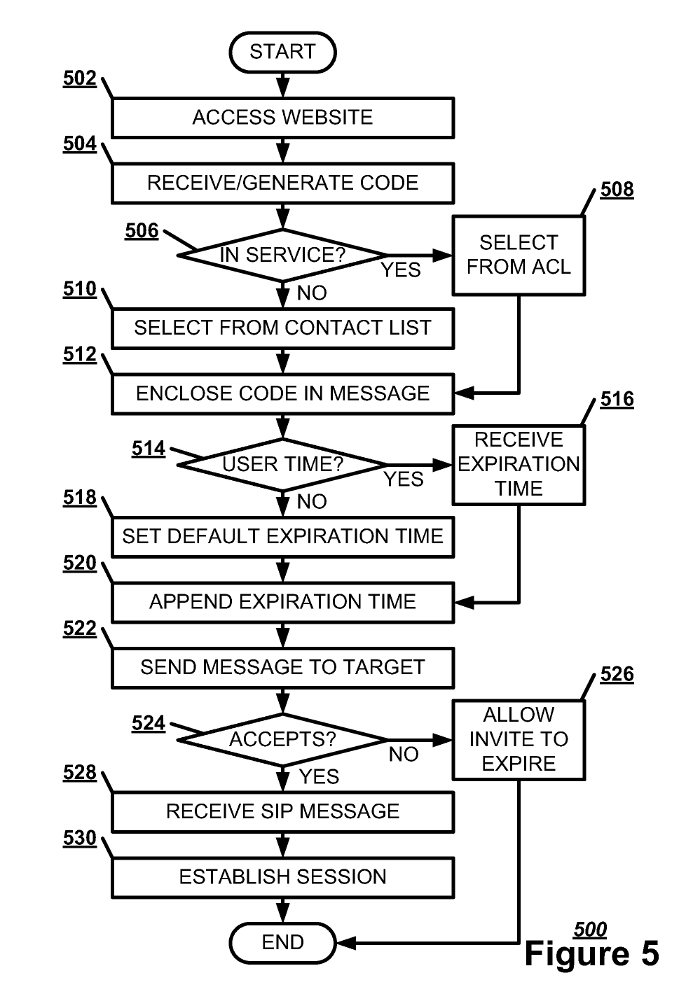

FIG. 5 illustrates, in a flowchart, one embodiment of a method 500 of initiating a video chat with a video chat target. The video chat source 102 may access a video chat website 106 to execute a video chat session with the video chat target (Block 502). The video chat source 102 may receive a video chat establishment code 340 to initiate a video chat session from the video chat website 106 (Block 504). Alternately, the video chat source 102 may generate the video chat establishment code 340. The video chat establishment code 340 may be hypertext markup language, JavaScript®, or some other internet programming language.

If the video chat source 102 and the video chat target 104 are both members of the same video service (Block 506), the video chat source 102 may select the video chat target 104 from an access control list (ACL) (Block 508). If the video chat source 102 and the video chat target 104 are not members of the same video service (Block 506), the video chat source 102 may select the video chat target 104 from a general contact list (Block 510). The video chat source 102 may enclose the video chat establishment code 340 in a chat invitation message 300 (Block 512).

If the user enters an expiration time 350 for the invitation for the video chat session (Block 514), the video chat source 102 may receive an expiration time 350 from the user (Block 516). If the user does not enter an expiration time 350 (Block 514), the video chat source 102 may set a default expiration time 350 (Block 518). The video chat source 102 may append an expiration time 350 in the chat invitation message 300 (Block 520). The video chat source 102 may send the chat invitation message 300 to the video chat target 104 (Block 522). The video chat source 102 may send the chat invitation message 300 in an electronic mail message 404, a short messaging service text, an instant message, or a social network page post 454.

If the video chat target 104 does not accept the chat invitation message 300 before the expiration time 350 (Block 524), the video chat source may allow the chat invitation message to expire (Block 526). If the video chat target 104 accepts the chat invitation message 300 before the expiration time 350 (Block 524), the video chat source 104 may receive a session initiation protocol (SIP) message (Block 528). The video chat source may establish the video chat session upon receipt of the session initiation protocol message (Block 530).

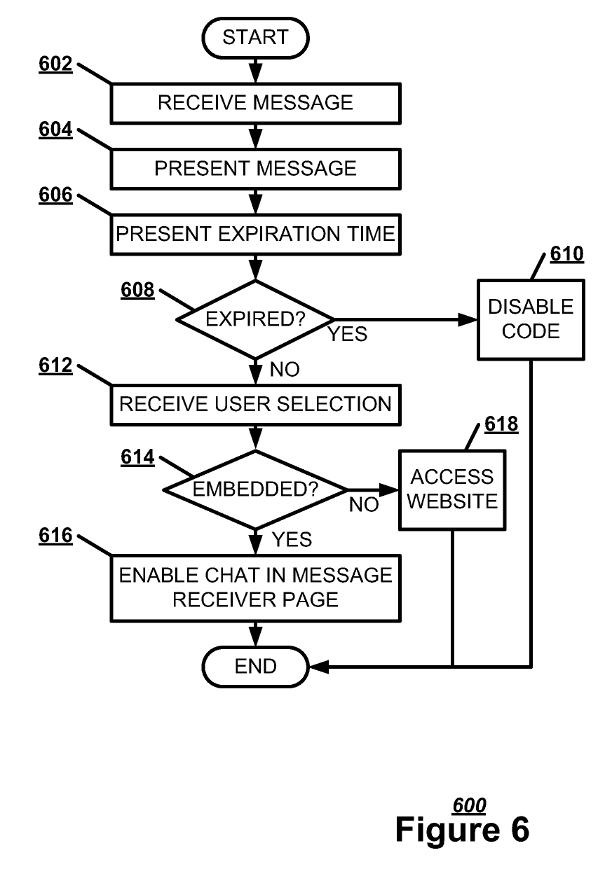

FIG. 6 illustrates, in a flowchart, one embodiment of a method 600 of receiving a video chat initiation from a video chat source. The video chat target 104 may receive a chat invitation message 300 with a video chat establishment code 340 to initiate a video chat session (Block 602). The video chat target 104 may receive the chat invitation message 300 in an electronic mail message 404, a short messaging service text, an instant message, or a social network page post 454. The video chat target 104 may present the chat invitation message 300 and the video chat establishment code 340 to a user in a chat invitation message receiver application (Block 604). The chat invitation message receiver application may be an electronic mail website 402, a social network page 452, an instant message website, a short messaging service texting application, or other application. The video chat target 104 may present an expiration time 350 in the chat invitation message 300 (Block 606).

If the expiration time 350 has passed (Block 608), the video chat target 104 may disable the video chat establishment code (Block 610). Otherwise, the video chat target 104 may receive a selection of the video chat establishment code 340 from the user (Block 612).

If the chat invitation message receiver application allows for an embedded video chat session (Block 614), the video chat target 104 may enable a video chat session interface 406 in the chat invitation message receiver application (Block 616). Otherwise, the video chat target 104 may access a video chat website 106 to execute the video chat session with a video chat source 102 (Block 618).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
enclosing in a chat invitation message a video chat establishment code to initiate a video chat session; and
sending the chat invitation message to a video chat target.

2. The method of claim 1, further comprising:
sending the chat invitation message in at least one of an electronic mail message, a short messaging service text, an instant message, and a social network page post.

3. The method of claim 1, further comprising:
appending an expiration time in the chat invitation message.

4. The method of claim 3, further comprising:
receiving the expiration time from a user.

5. The method of claim 3, further comprising:
setting a default expiration time.

6. The method of claim 1, further comprising:
generating the video chat establishment code in at least one of hypertext markup language and JavaScript®.

7. The method of claim 1, further comprising:
receiving the video chat establishment code from a video chat website.

8. The method of claim 1, further comprising:
accessing a video chat website to execute the video chat session with the video chat target.

9. The method of claim 1, further comprising:
selecting the video chat target from a general contact list.

10. The method of claim 1, further comprising:
selecting the video chat target from an access control list.

11. The method of claim 1, further comprising:
receiving a session initiation protocol message if the video chat target accepts the chat invitation message.

12. A tangible machine-readable medium having a set of instructions detailing a method stored thereon that when executed by one or more processors cause the one or more processors to perform the method, the method comprising:
receiving a chat invitation message with a video chat establishment code to initiate a video chat session;
presenting the chat invitation message and the video chat establishment code to a user in a chat invitation message receiver application; and
receiving a selection of the video chat establishment code from the user.

13. The tangible machine-readable medium of claim 12, wherein the method further comprises:
receiving the chat invitation message in at least one of an electronic mail message, an instant message, a short messaging service text, and a social network page post.

14. The tangible machine-readable medium of claim 12, wherein the method further comprises:
presenting an expiration time in the chat invitation message.

15. The tangible machine-readable medium of claim 12, wherein the method further comprises:
disabling the video chat establishment code if the expiration time has passed.

16. The tangible machine-readable medium of claim 12, wherein the method further comprises:
accessing a video chat website to execute the video chat session with a video chat source.

17. The tangible machine-readable medium of claim 12, wherein the method further comprises:
enabling a video chat session interface in the chat invitation message receiver application.

18. A video chat source, comprising:
a processor that encloses in a chat invitation message a video chat establishment code to initiate a video chat session; and
a communication interface that accesses a video chat website and sends the chat invitation message to a video chat target.

19. The video chat source of claim 18, wherein the chat invitation message has an expiration time.

20. The video chat source of claim 18, wherein the chat invitation message in at least one of an electronic mail, a short messaging service text, an instant message, and a social network page post.
